(19) United States
(12) Patent Application Publication
(10) Pub. No.: US 2008/0046604 A1
(43) Pub. Date: Feb. 21, 2008

(54) Storage device and control chip for the storage device

(75) Inventor: Cheng-Kai Jhan, Taipei Hsien (TW)

Correspondence Address: BIRCH STEWART KOLASCH & BIRCH, PO BOX 747, FALLS CHURCH, VA, 22040-0747, US

(73) Assignee: ICP Electronics Inc.

(21) Appl. No.: 11/703,759

(22) Filed: Feb. 8, 2007

(30) Foreign Application Priority Data
Aug. 18, 2006 (TW) 95130556

(51) Int. Cl. G06F 13/28; G06F 3/00

(52) U.S. Cl. 710/22; 710/52

(57) ABSTRACT

A storage device is applied to a computer. The storage device comprises a control chip having a microprocessor, a buffer storage, a bus interface, a storage memory interface and a storage memory. The microprocessor controls the buffer storage to read or to write the data of the storage memory via the storage memory interface and then transmits the data to the CPU of the computer via the bus interface. A power supply is connected to the control chip and the storage memory to prevent the data from disappearing.

### FIELD OF THE INVENTION

The present invention relates to a virtual hard disk, and more specifically to a storage device and a control chip thereof to be set by a software.

### BACKGROUND OF THE INVENTION

Following the advancement of technology, the microminiaturization of electronic components, enhancing functions of personal electronic apparatus and mobile equipments become the mainstream focus. For instance, the function of the PC is stronger than ever due to the advancement in semiconductor. The occupation capacity for application programs, software and multimedia become hugely, and thereupon storing equipment needs to be promoted so as to improve the capacity and the access speed. In the art, there are three kinds of storing equipments on the market: electromagnetic storing equipment, optic storing equipment and non-volatile memory. The electromagnetic storing equipments comprise floppy disks and hard disks, etc. The optic storing equipments comprise compact discs recordable rewritable (CD-RW) and digital video discs recordable rewritable (DVD-RW), etc. The non-volatile memories comprise read-only memories (ROM), electrically erasable programmable read-only memories (EEPROM), flash memories (Flash) to provide a high density capacity in a small size.

The main storage of computer is the hard disk due to its great storing capacity, rewritable characteristic, and cheaper price than the non-volatile memory. A problem of the hard disk is that it spends too much time to seek data. The main reason why both the seek time of moving magnetic head to search the data and the rotation time of the spindle motor can't be reduced is that the hard disk can't provide a considerable memory to pair the access speed of the computer. For the computer, most of the data are stored in the hard disk. When the computer reads data from or writes data to the hard disk, the process time is mainly defined by the access time of the hard disk, not by the faster operating speed of the CPU.

The diligent goal for many developers is to promote the speed of the hard disk and to reduce the time for searching data. There already exist various kinds of technology in reducing the access time; for example, using a part of the cache memory or the main memory connected to a power source as a virtual disk. When the computer is shut down, the connected power source can still prevent the data stored in the memory from disappearing. The memory also connects to a controller to convert the data from the interface of the hard disk to the interface of the memory. Reversibly, the data stored in the memory can also be shifted to the hard disk by the controller. The method of using the memory as the virtual disk has some defects. For example, one is that the storing capacity of shared memory is not big enough, and one is the conversion time of the controller is consumed too long. Currently, it is not obvious in the art how to improve the access time, for most of data are still stored in the hard disk.

So, the present invention is devoted to improving the storage device which can access faster, transfer data without detouring to a conventional disk interface, and work unlimited by the standard bandwidth of the conventional disk interface.

### SUMMARY OF THE INVENTION

The objective of the present invention is to improve a storage device, which can access faster, transfer data without detouring to a conventional disk interface, and work unlimited by the standard bandwidth of the conventional disk interface.

The storage device comprises a control chip coupled to the main bus interface to process the signals form the CPU and a storage memory connected to and controlled by the control chip. The control chip coupled to the CPU via the main bus interface controls to read from or to write to the storage memory.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the following detailed description and the accompanying drawings, which are given by way of illustration only, and thus are not limitative of the present invention, and in which:

FIG. 1 illustrates one embodiment of a computer structure of the present invention;

FIG. 2 illustrates one embodiment of a storage device having a function of a virtual hard disk of the present invention;

FIG. 3 illustrates a flow chart of reading data of the storage device in the present invention; and

FIG. 4 illustrates a flow chart of writing data of the storage device in the present invention.

### DETAILED DESCRIPTIONS OF THE PREFERRED EMBODIMENT

The present invention is to provide a storage device applied to a computer as an emulated hard-disk drive. The storage device is different from the hard-disk drive in the access manner. The data access of a conventional hard disk is to use a linear motor (stepping motor) that moves the arms on a surface of a platter in the hard disk to read or to write data. On the other hand, the storage device of the present invention is composed of volatile memories or non-volatile memories. The access time of the storage device can be improved largely by omitting the mechanical operation, and thus the operation speed of the computer having the storage device can be greatly improved.

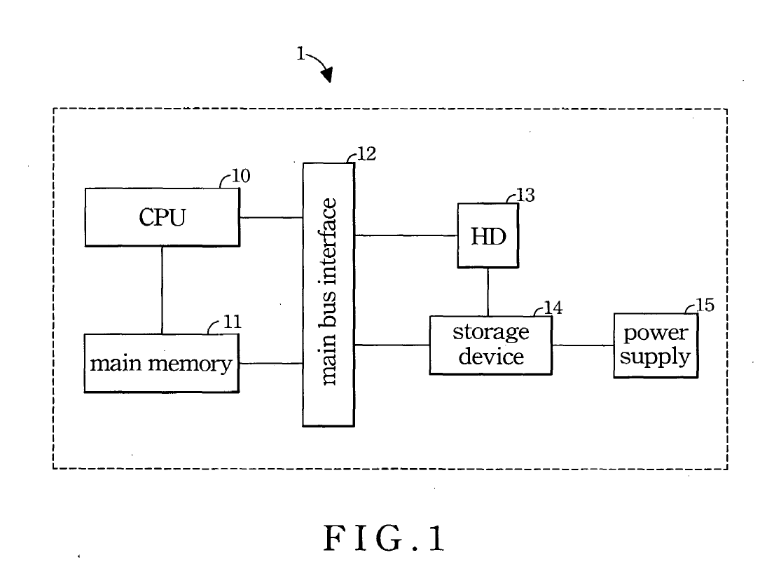

Please refer to FIG. 1, which shows a computer structure according to the present invention. The computer 1 comprises: a central processing unit (CPU) 10, a main bus interface 12 coupled to the CPU 10 to transmit signals, a hard disk 13 coupled to the CPU 10 via the main bus interface 12 to store data permanently, a main memory 11 coupled to the CPU 10 to store data and programs temporarily, a storage device 14 coupled to the CPU 10 via the main bus interface 12 to store data permanently, and a power supply 15 coupled to the storage device 14 to prevent the data of the storage device 14 from disappearing. As illustrated in FIG. 1, the hard disk 13 and the storage device 14 are individually connected to the CPU 10 via the main bus interface 12, while the main memory 11 is connected directly to the CPU 10. The CPU 10 accesses data and programs from the hard disk 13 or the storage device 14 via the main bus interface 12, and the CPU 10 also temporarily stores the data and programs in the main memory 11 during the operation. The temporary data and programs of the main memory 11 are provided to speed up the CPU operation.

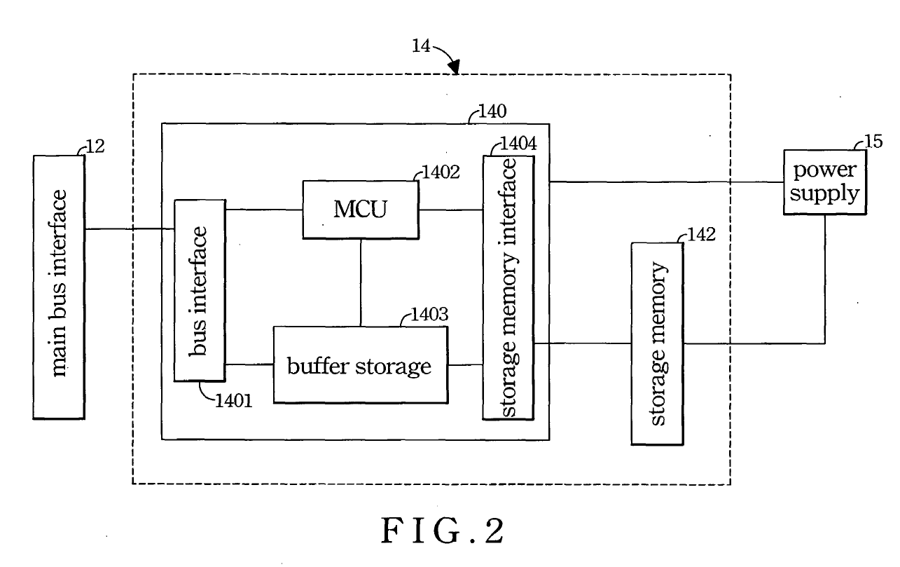

Please refer to FIG. 2, which shows one embodiment of the storage device according to the present invention. The storage device 14 comprises a control chip 140 and a storage memory 142. The control chip 140 is coupled to the main bus interface 12 to process the signals form the CPU. The storage memory 142 is connected to and controlled by the control chip 140.

The storage memory 142 can be composed of volatile memories or non-volatile memories in this embodiment. If the storage memory 142 uses the volatile memories, the storage device 14 is connected to the power supply 15 in order to prevent the data from disappearing while the computer is shut off. The power supply 15 is connected to the control chip 140 and the storage memory 142 to prevent the data of the storage memory 142 from disappearing and provides a standard voltage to the storage device 14. The power supply 15 can facilitate the data reserve of the storage device 14.

The control chip 140 further comprises a bus interface 1401, a microprocessor (MCU) 1402, a buffer storage 1403 and a storing memory interface 1404. The buffer storage 1403 includes a direct memory access (DMA) and a buffer. The DMA can transfer data to and from the storage memory 142 directly without detouring through the CPU 10. Namely, the DMA can copy a block of memory from one device to another without involving the CPU. A typical usage of the DMA is to copy a block of memory from the main memory to or from a buffer on the storage device 14, so that the DMA can determine the route of data transfer. The buffer is used to store the transmissive data read and/or written from the storage memory temporarily. The MCU 1402, coupled to the main bus interface 12 via the bus interface 1401 to transmit signals, is used to set the buffer storage 1403 to read from or to write to the storage memory 142 via the storage memory interface 1404.

At first, the storage device 14 is installed into the computer by software, and is set as a virtual disk. After the storage device 14 is installed, when the computer is turned on, the computer will start the readiness review of the storage device 14 independent of the operating system. The CPU 10 outputs a signal to read a device class via the main bus interface, and the MCU 1402 of the storage device 14 responds to the CPU 10 with a mass storage class like hard disks and some related information via the bus interface 1401 and the main bus interface 12. After the readiness review is started, the storage device 14 is deemed as a mass storage for the operating system.

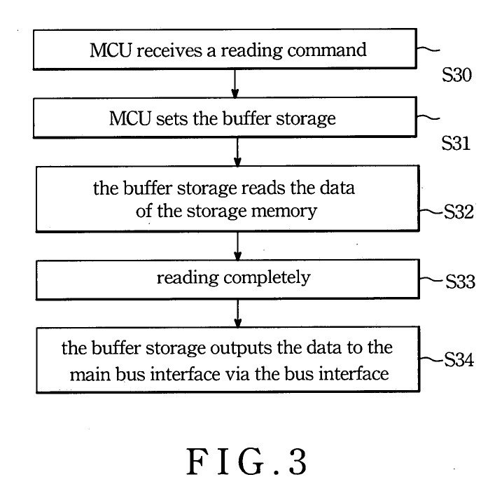

Please refer to FIG. 3, which shows a flow chart of reading data from the storage device according to the present invention. The CPU of the computer accesses data from the storage device by the following steps.

Step S30, the CPU transmits a reading command to the storage device via the main bus interface, and the MCU receives the reading command via the bus interface. Step S31, the MCU sets the buffer storage after receiving the reading command. Step S32, the buffer storage reads the data with the address of the storage memory and the data width via the storage memory interface, and the buffer storage advances to write the address and the data width to the main bus interface. Then, the data reading from the storage memory is stored into the buffer of the buffer storage via the storage memory interface. Step S33, the MCU waits for all the data to be read (copied) completely. Step S34, the buffer storage outputs the data to the main bus interface to respond to the CPU's reading command via the bus interface.

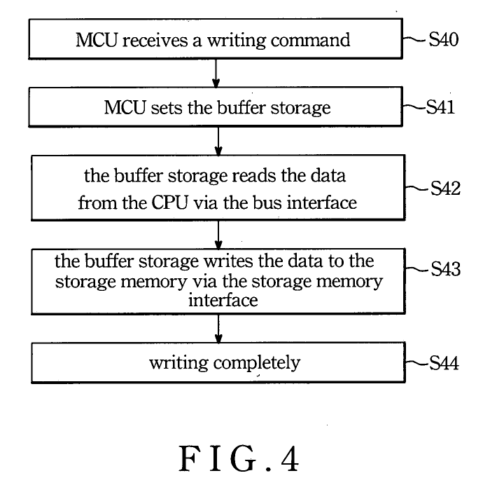

Please refer to FIG. 4, which shows a flow chart of writing data to the storage device according to the present invention. The CPU of the computer accesses data to the storage device by the following steps.

Step S40, the CPU transmits a writing command to the storage device via the main bus interface, and the MCU receives the writing command via the bus interface. Step S41, the MCU sets the buffer storage after receiving the writing command. Step S42, the buffer storage reads the data with the address of the main bus interface and the data width, and the buffer storage advances to write the address and the data width to the storage memory. Then, the data writing from the main bus interface is stored into the buffer of the buffer storage till all the data are copied completely. Step S43, the buffer storage outputs the data to the storage memory via the storage memory interface. Step S44, after finishing the writing process, the MCU responds to the CPU's writing command.

Compared with the structure of the conventional hard disk, the present invention is employing the memories to be a storage which does not have mechanical shock problem by the stepping motor. The access speed of the storage device is the same as the main memory but faster than the hard disk because the storage device can omit the electric machinery operation. The storage device and the main memory are independent memory systems, so that the storage device does not occupy the resources of the main memory in the computer. For its software is suitable for most of the operating systems, the storage device can be easily installed into any operating system.

Although the present invention and its advantages have been described in detail, as well as some variations over the disclosed embodiments, it should be understood that various other changes, substitutions and alterations can be made herein without departing from the spirit and scope of the invention as defined by the appended claims.

1. A storage device, set as an emulating hard disk (virtual disk) of a computer by software, comprising:
a control chip, having a microprocessor, a buffer storage, a bus interface and a storage memory interface, wherein said microprocessor couples to a central processing unit (CPU) of said computer via said bus interface and controls said buffer storage to temporarily store data; and
a storage memory, coupled to said control chip via said storage memory interface, used to store data and programs from the computer permanently;
wherein said microprocessor controls said buffer storage to read or to write data of said storage memory via said storage memory interface and then transmits data to said CPU via said bus interface.

2. The storage device of claim 1, wherein said buffer storage further comprises a direct memory access (DMA) for determining a route of data transfer.

3. (canceled)

4. The storage device of claim 1, wherein said storage memory is a non-volatile memory.

5. The storage device of claim 1, further connected to a power supply connected to said control chip and said storage memory to prevent data from disappearing.

6. A control chip applied to control a storage memory, comprising:
a bus interface, coupled to an external computer, used to transmit data and signals;
a buffer storage coupled to said bus interface to temporarily keep data from/to said storage memory;
a storage memory interface for connecting said storage memory to said buffer storage; and
a microprocessor connected to said bus interface and said buffer storage, for processing the signals from a CPU of said computer and controlling said buffer storage to temporarily keep the data read from said storage memory via said storage memory interface or to temporarily keep the data to be written to said storage memory via said bus interface.

7. The control chip of claim 6, wherein said buffer storage further comprises a direct memory access for determining a route of data transfer.

8. The storage device of claim 5, wherein said storage memory is a volatile memory.

9. A computer, having an emulating hard disk (virtual disk), comprising:
a central processing unit (CPU);
a hard disk, connected to the CPU to store data permanently;
a main memory, connected to the CPU to store data and programs temporarily; and
a storage device, connected to the CPU to store data permanently and served as said emulating hard disk (virtual disk).

10. The computer of claim 9, further comprising a main bus interface, connected to the CPU to transmit signals.

11. The computer of claim 9, further comprising a power supply connected to the storage device to prevent the data of the storage device from disappearing.

12. The computer of claim 11, wherein said storage device includes a volatile memory.

13. The computer of claim 9, wherein said storage device includes a non-volatile memory.

14. The computer of claim 13, wherein said hard disk is connected to the CPU via the main bus interface.

15. The computer of claim 13, wherein said storage device is connected to the CPU via the main bus interface.

16. The computer of claim 13, wherein said main memory is connected directly to the CPU.
